(19) United States
(12) Patent Application Publication
(10) Pub. No.: US 2026/0166710 A1
(43) Pub. Date: Jun. 18, 2026

(54) AUTONOMOUS MOBILE ROBOT FOR TRANSPORTING MATERIAL IN A MANUFACTURING ENVIRONMENT

(71) Applicant: GM Global Technology Operations LLC, Detroit, MI (US)

(72) Inventors: Joshua Lee Solomon, Berkley, MI (US); James Butterworth, Mount Clemens, MI (US); Chen Chen, Troy, MI (US); Jesse Heidrich, Shelby Township, MI (US); Macey Salyer, Berkley, MI (US); Peter W. Tavora, Oxford, MI (US); Laura Marcela Gonzales, Birmingham, MI (US); Breona Warren, Sterling Heights, MI (US); Joel S. Hooton, Chesterfield, MI (US); Kevin K. Parkila, Royal Oak, MI (US); Rob John Kempf, Austin, TX (US); Jeffrey Paul Mulnix, Linden, MI (US); James Edward Kettlewell, Windsor (CA)

(21) Appl. No.: 18/980,611

(22) Filed: Dec. 13, 2024

(51) Int. Cl. B25J 5/00; B25J 19/02; B66F 9/06

(52) U.S. Cl. CPC B25J 5/005; B25J 19/022; B66F 9/063

(57) ABSTRACT

An autonomous mobile robot transporting material in a manufacturing environment includes a chassis including a main body that defines two opposing sides, a front side, a rear side, and a lower surface that faces a terrain that the autonomous mobile robot traverses. The main body defines two or more channels disposed along the lower surface of the main body that are each shaped to receive an arm of a lifting mechanism. The autonomous mobile robot also includes a track drive system including two drive systems that are each attached to one of the two opposing sides of the chassis. Each drive system includes a track, a pair of driven wheels, and one or more idler wheels disposed between the pair of driven wheels, where the track engages the pair of driven wheels and the idler wheel.

### INTRODUCTION

The present disclosure relates to an autonomous mobile robot for transporting material in a manufacturing environment.

Autonomous mobile robots are mobile systems that navigate and respond to uncontrolled environments without physical or electromechanical guidance, and also without being limited in movement along a fixed, predetermined path. In one implementation, an autonomous mobile robot may be employed to transport materials within a manufacturing environment. Specifically, the autonomous mobile robot may transport materials from storage or receiving locations to an order fulfillment or point-of-use destination within a manufacturing facility.

Although autonomous mobile robots achieve their intended purpose of transporting materials, there are several challenges that they face in a manufacturing environment. For example, current autonomous mobile robots include wheels or casters that sometimes have issues traversing irregular terrain. In particular, features such as cracks, divots, pits, and uneven transitions along the floor of a manufacturing facility create difficulties as an autonomous mobile robot attempts to traverse the terrain. Furthermore, various items commonly found in a manufacturing facility such as bolts, nails, and nuts may fall upon the floor and tend to get stuck in the wheels of an autonomous mobile robot, which may prevent forward motion. The autonomous mobile robot may back up and attempt to resume forward travel, however, this may be especially challenging since the autonomous mobile robot is not aware of what specific item is preventing forward motion. Additionally, many autonomous mobile robots have low ground clearance. While low ground clearance does result in a lower overall height, low ground clearance results in less terrain variation that an autonomous mobile robot may accommodate.

In addition to the above-mentioned challenges, it is also to be appreciated that current autonomous mobile robots are not easily moved when they are not powered due to electrical or hardware issues as well as during maintenance. Moreover, there are not many convenient options available to remove an immobilized autonomous mobile robot from the floor of the manufacturing facility. In fact, sometimes it may take hours or even days to repair or service an autonomous mobile robot depending upon the issue.

Autonomous mobile robots may also include numerous wires and controllers that are mounted to a central chassis/frame. The numerous wires and controllers are highly integrated and may create issues during manufacturing and service since it is not efficient to replace only a few components without disassembling a majoring of the autonomous mobile robot. Furthermore, many current autonomous mobile robots have a footprint that is smaller than the material cart that they carry. This mismatch in size may create issues with computer vision during navigation. Many autonomous mobile robots may also require lift mechanisms that interface with rolling carts or racks. As a result, the docking and undocking procedure between the autonomous mobile robot and the rolling cart or rack requires precise alignment and may become time consuming.

Thus, while current autonomous mobile robots achieve their intended purpose, there is a need in the art for an autonomous mobile robot that addresses the above-mentioned issues.

### SUMMARY

According to several aspects, an autonomous mobile robot transporting material in a manufacturing environment is disclosed. The autonomous mobile robot includes a chassis including a main body that defines two opposing sides, a front side, a rear side, and a lower surface that faces a terrain that the autonomous mobile robot traverses. The main body defines two or more channels disposed along the lower surface of the main body that are each shaped to receive an arm of a lifting mechanism. The autonomous mobile robot also includes a track drive system including two drive systems that are each attached to one of the two opposing sides of the chassis. Each drive system includes a track, a pair of driven wheels, and one or more idler wheels disposed between the pair of driven wheels, where the track engages the pair of driven wheels and the idler wheel.

In another aspect, each channel of the chassis extends from the front side to the rear side of the chassis.

In yet another aspect, a clearance is measured between the lower surface along one of the channels of the chassis and the terrain that the autonomous mobile robot traverses.

In an aspect, the autonomous mobile robot further includes two motors and two gearboxes, where each of the two motors correspond to and drive one of the drive systems and the two gearboxes are each directly connected to one of the two motors.

In another aspect, the two or more channels are load-bearing members of the chassis.

In yet another aspect, the autonomous mobile robot further includes two or more cameras, where a first camera is disposed along the front side of the chassis and a second camera is disposed along the rear side of the chassis.

In an aspect, the autonomous mobile robot includes a LiDAR sensor disposed on each of the two opposing sides, the front side, and the rear side of the chassis.

In another aspect, a first height is measured between the terrain and one of the two or more cameras is greater than a second height measured between one of the LiDAR sensors and the terrain.

In yet another aspect, the main body of the chassis defines one or more cavities.

In an aspect, the autonomous mobile robot further includes a support plate seated on top of an upper surface of the main body of the chassis to cover the one or more cavities.

In another aspect, the autonomous mobile robot further includes a pallet seated on top of an upper surface of the support plate.

In yet another aspect, the pallet includes a main body that defines a support surface and a plurality of apertures that are distributed in a grid pattern.

In an aspect, the track of the track drive system includes an inner surface and an outer surface.

In another aspect, the inner surface of the track includes a plurality of inner teeth that engage with corresponding teeth disposed around the pair of driven wheels and the outer surface of the track includes a plurality of outer teeth.

In yet another aspect, an autonomous mobile robot transporting material in a manufacturing environment is disclosed. The autonomous mobile robot includes a chassis including a main body that defines two opposing sides, a front side, a rear side, and a lower surface that faces a terrain that the autonomous mobile robot traverses. The main body defines two or more channels disposed along the lower surface of the main body that are each shaped to receive an arm of a lifting mechanism, and each channel of the chassis extends from the front side to the rear side of the chassis. The autonomous mobile robot also includes a track drive system including two drive systems that are each attached to one of the two opposing sides of the chassis. Each drive system includes a track including an inner surface including a plurality of inner teeth and an outer surface including a plurality of outer teeth, a pair of driven wheels including corresponding teeth, where the plurality of inner teeth of the track engage with the corresponding teeth disposed around the pair of driven wheels, and one or more idler wheels disposed between the pair of driven wheels, where the track engages the pair of driven wheels and the idler wheel.

In an aspect, the autonomous mobile robot further includes two or more cameras, where a first camera is disposed along the front side of the chassis and a second camera is disposed along the rear side of the chassis and a LiDAR sensor disposed on each of the two opposing sides, the front side, and the rear side of the chassis.

In another aspect, the main body of the chassis defines one or more cavities.

In yet another aspect, the autonomous mobile robot further includes a support plate seated on top of an upper surface of the main body of the chassis to cover the one or more cavities.

In an aspect, the autonomous mobile robot further includes a pallet seated on top of the upper surface of the support plate.

In another aspect, an autonomous mobile robot transporting material in a manufacturing environment is disclosed. The autonomous mobile robot includes a chassis including a main body that defines one or more cavities, an upper surface, two opposing sides, a front side, a rear side, and a lower surface that faces a terrain that the autonomous mobile robot traverses. The main body defines two or more channels disposed along the lower surface of the main body that are each shaped to receive an arm of a lifting mechanism, and each channel of the chassis extends from the front side to the rear side of the chassis. The autonomous mobile robot also includes a support plate seated on top of an upper surface of the main body of the chassis to cover the one or more cavities. The autonomous mobile robot also includes a pallet seated on top of the upper surface of the support plate. The autonomous mobile robot also includes a track drive system including two drive systems that are each attached to one of the two opposing sides of the chassis. Each drive system includes a track including an inner surface including a plurality of inner teeth and an outer surface including a plurality of outer teeth, a pair of driven wheels including corresponding teeth, where the plurality of inner teeth of the track engage with the corresponding teeth disposed around the pair of driven wheels, and one or more idler wheels disposed between the pair of driven wheels, where the track engages the pair of driven wheels and the idler wheel.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of the disclosed autonomous mobile robot including a track drive system, a chassis, a plurality of perception sensors, and a pallet, according to an exemplary embodiment;

FIG. 2A is an assembly view of the autonomous mobile robot shown in FIG. 1, according to an exemplary embodiment;

FIG. 2B illustrates the chassis, where two motors and a gearbox that are located within the cavities of the chassis are visible, according to an exemplary embodiment;

FIG. 3 is a side view of the autonomous mobile robot showing one of the drive systems that are part of the track drive system, according to an exemplary embodiment;

FIG. 4 is an enlarged view of one of the tracks shown in FIG. 3, according to an exemplary embodiment;

FIG. 5 is a front view of the autonomous mobile robot, according to an exemplary embodiment;

FIG. 6 is a bottom view of the autonomous mobile robot showing the lower surface of the chassis and two channels, according to an exemplary embodiment; and

FIG. 7 is a perspective view of a forklift including a pair of arms that correspond to the two channels of the chassis shown in FIG. 6, according to an exemplary embodiment.

### DETAILED DESCRIPTION

The following description is merely exemplary in nature and is not intended to limit the present disclosure, application, or uses.

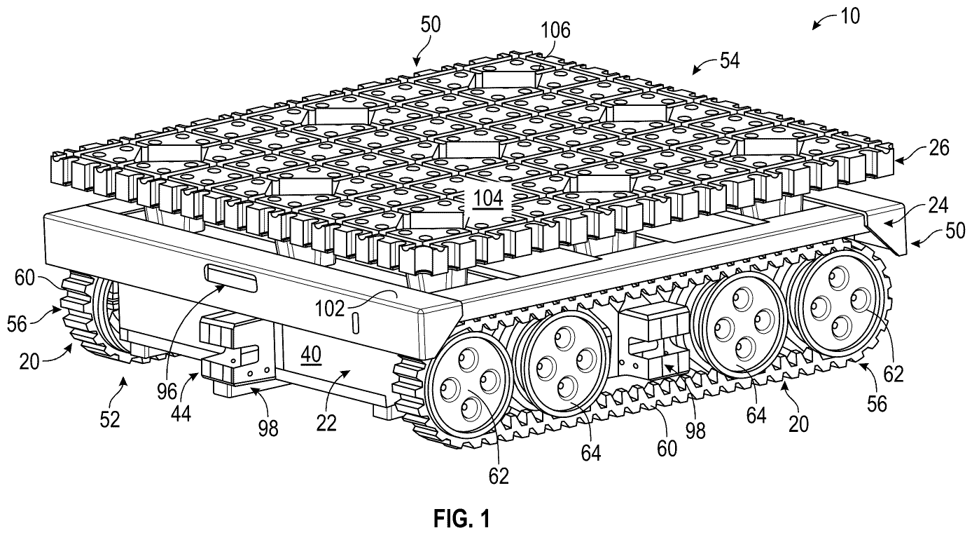

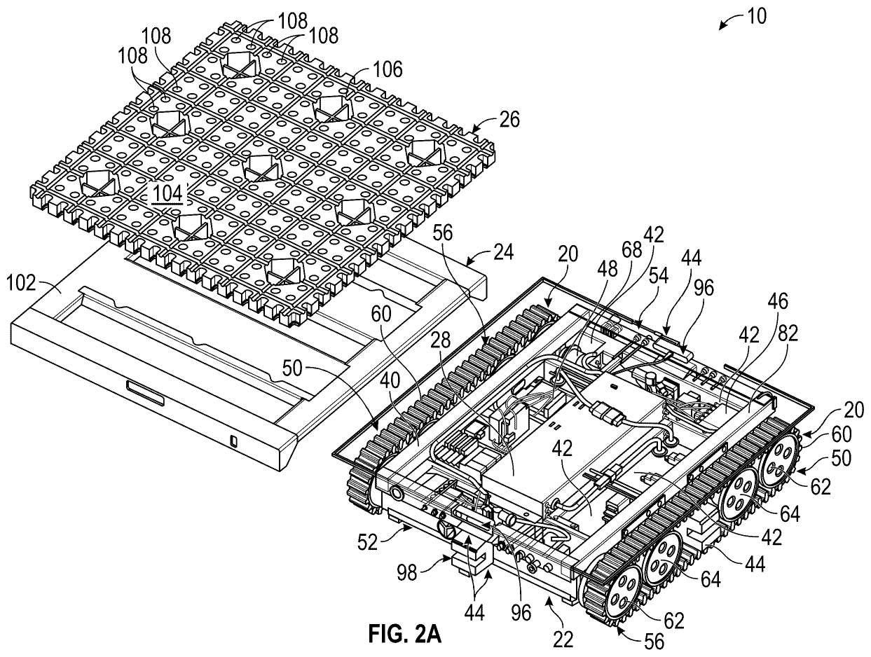

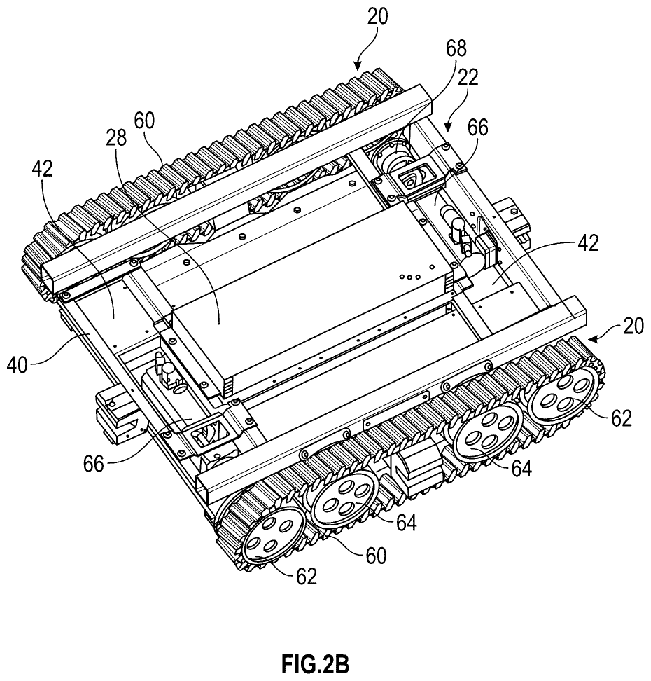

Referring to FIG. 1, a perspective view of the disclosed autonomous mobile robot 10 is illustrated. The autonomous mobile robot 10 navigates and responds to uncontrolled events within a manufacturing environment without requiring outside intervention while transporting materials. FIG. 2A is an assembly view of the autonomous mobile robot shown in FIG. 1. Referring to both FIGS. 1 and 2A, the autonomous mobile robot 10 includes a track drive system 20, a chassis 22, a support plate 24, a pallet 26, and a housing 28 (seen in FIG. 2A) that contains one or more rechargeable battery modules (the one or more rechargeable battery modules are not visible in the figures).

Referring specifically to FIG. 2A, the chassis 22 includes a main body 40 that defines one or more cavities 42 that are shaped to contain a plurality of electrical components such as, for example, the housing 28 that contains the one or more battery modules, a plurality of perception sensors 44, and one or more controllers 46. As seen in FIG. 2A, the housing 28 containing the one or more rechargeable battery modules is positioned within a central area 48 of the one or more cavities 42 of the chassis 22. The one or more rechargeable battery modules may include, for example, a lead-acid or lithium-ion batteries, and provides the electrical power required to operate the autonomous mobile robot 10. The support plate 24 is a protective plate that is seated on top of an upper surface 82 of the main body 40 of the chassis 22 and covers the one or more cavities 42 of the chassis 22. The one or more controllers 46 are in electronic communication with the track drive system 20, the one or more battery modules, and the plurality of perception sensors 44.

The chassis 22 defines two opposing sides 50, a front side 52, and a rear side 54. The track drive system 20 includes two drive systems 56, where each drive system 56 is attached to one of the two opposing sides 50 of the chassis 22. Each drive system 56 includes a track 60, a pair of driven wheels 62, and one or more idler wheels 64 disposed between the pair of driven wheels 62. FIG. 2B illustrates the chassis 22, where several of the electrical components located within the one or more cavities 42 have been removed to more clearly show two motors 66, where each motor 66 corresponds to and drives one of the drive systems 56. It is to be appreciated that two gearboxes 68 are each directly connected to one of the two motors 66, however, only one of the gearboxes 68 are visible in FIG. 2B. In the embodiment as shown, each motor 66 is positioned in line with the corresponding gearbox 68.

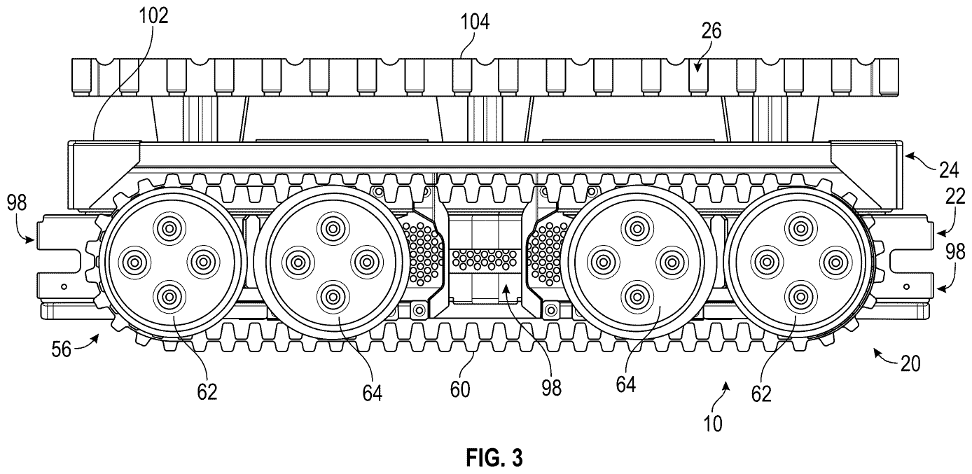

FIG. 3 is a side view of the autonomous mobile robot 10 illustrating one of the drive systems 56. The track 60 corresponding to each drive system 56 engages the respective driven wheels 62 and idler wheels 64. Referring to FIGS. 2B and 3, it is to be appreciated that each drive system 56 is operably connected to one of the two motors 66 via a corresponding gearbox 68, where each motor 66 drives a corresponding pair of driven wheels 62. Unlike existing designs, the autonomous mobile robot 10 does not include an integrated motor. In other words, the motors 66 are separate from the pair of driven wheels 62, which allows for upgrades, repair, and servicing of the motors 66 and the track drive system 20 without the need to disassemble the chassis 22. It is also to be appreciated that the components of the track drive system 20 such as the track 60, the pair of driven wheels 62, and the one or more idler wheels 64 may be easily replaced as well since they are separate components.

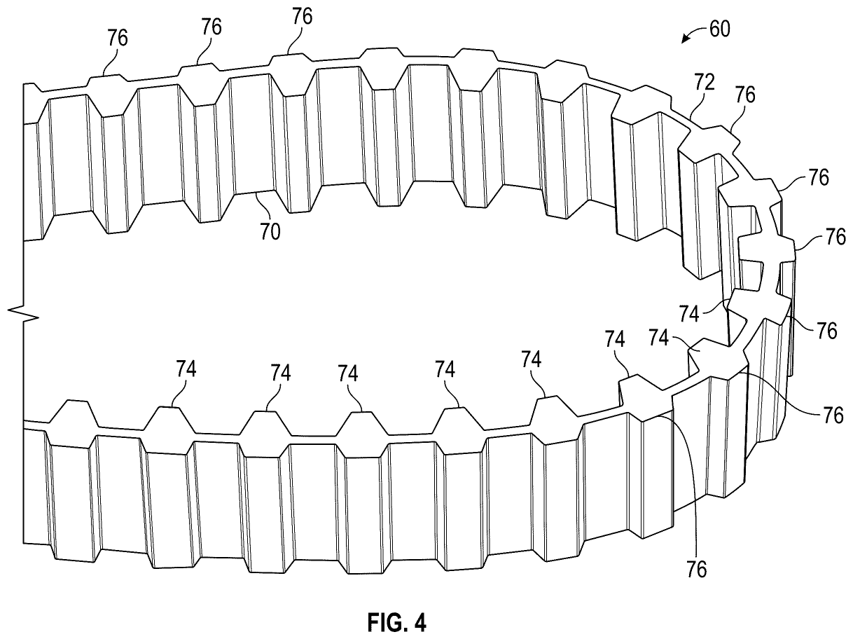

FIG. 4 is an enlarged view of one of the tracks 60 of the track drive system 20. Referring to both FIGS. 2A and 4, each track 60 of the track drive system 20 includes an inner surface 70 and an outer surface 72. The inner surface 70 of each track 60 includes a plurality of inner teeth 74 that engage with corresponding teeth (not visible in the figures) disposed around the pair of driven wheels 62. The outer surface 72 of each track 60 also includes a plurality of outer teeth 76 as well. Although the figures illustrate the tracks 60 including the inner teeth 74 and the outer teeth 76, it is to be appreciated that the figures are merely exemplary in nature, and the shape, geometry, and number of teeth may be changed depending upon the specific requirements of a particular application. Furthermore, the track 60 may also include other types of tread features in addition or in the alternative to the teeth 74, 76.

In the embodiment as shown in FIG. 4, the track 60 is a symmetrical double-sided belt, which means that the plurality of inner teeth 74 disposed along the inner surface 70 of the track 60 are aligned with the plurality of outer teeth 76 disposed along the outer surface 72 of the track 60. However, it is to be appreciated that in embodiments, the track 60 may include a staggered arrangement between the plurality of inner teeth 74 disposed along the inner surface 70 of the track 60 and the plurality of outer teeth 76 disposed along the outer surface 72 of the track 60.

It is to be appreciated that the track drive system 20 results in improved mobility across the floor of a manufacturing facility, since issues such as debris, irregularities along the floor, and uneven transitions are less of concern when compared to other types of mobility systems such as wheels and casters. Furthermore, the track drive system 20 also results in increased ground clearance when compared to wheels and casters. The track drive system 20 is able to traverse a variety of surfaces such as, for example, dirt, grass, sand, gravel, and concrete, unlike wheels and casters. The track drive system 20 is also capable of traversing relatively large gaps in the terrain, such as rail crossings and gaps created by a loading dock.

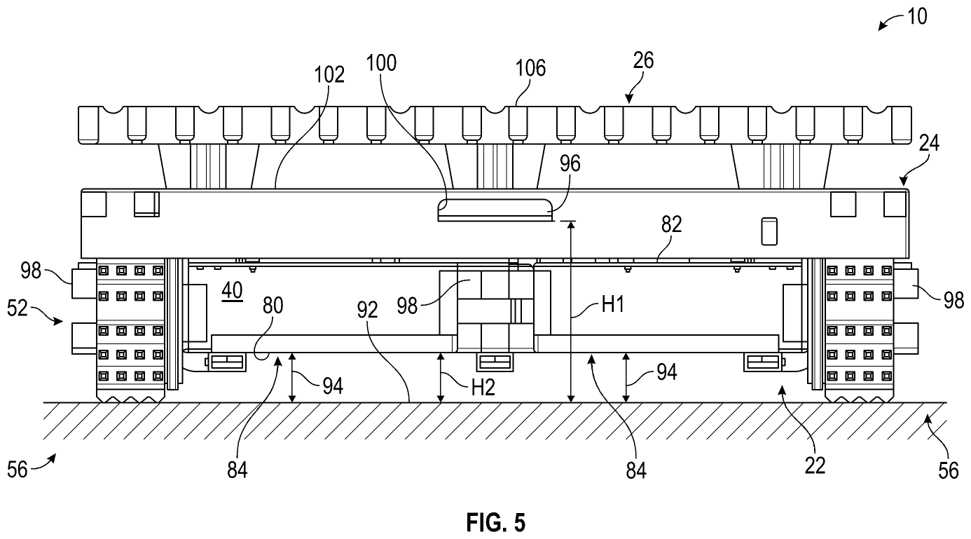

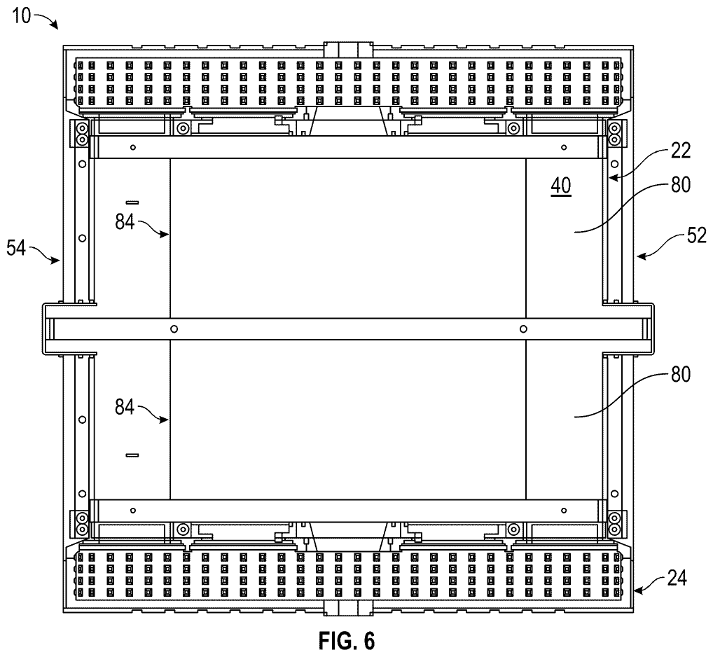

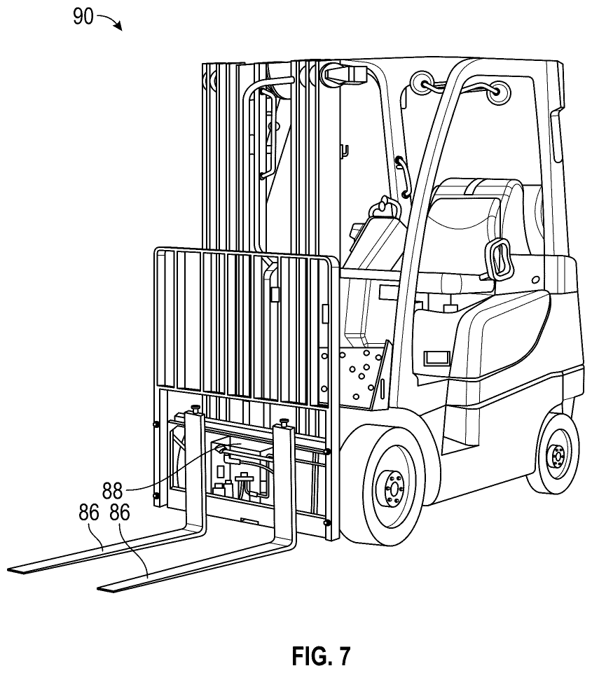

FIG. 5 illustrates the front side 52 of the chassis 22, however, it is to be appreciated that the rear side 54 of the chassis 22 includes the same configuration. The main body 40 of the chassis 22 defines a lower surface 80 and an upper surface 82, where the lower surface 80 of the chassis 22 faces the terrain 92 that the autonomous mobile robot 10 traverses and the upper surface 82 of the chassis 22 faces the support plate 24. FIG. 6 is a bottom view of the chassis 22 showing the lower surface 80. Referring to FIGS. 6 and 7, the main body 40 defines two or more channels 84 disposed along the lower surface 80 of the chassis 22 that are each shaped to receive an arm 86 (shown in FIG. 7) that are found on a load carriage 88 of a lifting mechanism 90. Although FIG. 7 illustrates the lifting mechanism 90 as a forklift, it is to be appreciated that any other type of lifting mechanism may be used as well such as, for example, a pallet jack. In the embodiment as shown in FIGS. 6 and 7, two channels 84 are disposed along the lower surface 80 of the main body 40 of the chassis 22, where each channel 84 extends from the front side 52 to the rear side 54 of the chassis 22.

Referring to FIGS. 6 and 7, each channel 84 of the chassis 22 is shaped to receive one of the individual arms 86 of the lifting mechanism 90. It is to be appreciated that the arms 86 of the lifting mechanism 90 are each placed directly underneath one of the channels 84 of the chassis 22. Accordingly, the arms 86 are received by and rest against a corresponding channel 84 of the chassis 22 of the autonomous mobile robot 10. The load carriage 88 of the lifting mechanism 90 is then raised so that the lifting mechanism 90 may support and carry the autonomous mobile robot 10. Thus, it is to be appreciated that the channels 84 are load-bearing members of the chassis 22.

Referring to FIG. 5, a clearance 94 is measured between the lower surface 80 along the channel 84 of the chassis 22 and the terrain 92 that the autonomous mobile robot 10 traverses. The clearance 94 is sized to accommodate the arms 86 of the lifting mechanism 90 (shown in FIG. 7). It is to be appreciated that the clearance 94 is greater than the clearance that may be found in current designs that employ other types of mobility systems such as wheels and casters. Thus, in the event the autonomous mobile robot 10 is immobilized due to electrical or hardware issues, or during maintenance, the autonomous mobile robot 10 may be easily lifted by the lifting mechanism 90 and transported to another area of the manufacturing facility for servicing.

Referring back to FIGS. 1 and 2A, in one embodiment the plurality of perception sensors 44 includes two or more cameras 96 and a LiDAR sensor 98 corresponding to the two opposing sides 50, the front side 52, and the rear side 54 of the chassis 22. In the non-limiting embodiment as shown in FIGS. 1 and 2A, the autonomous mobile robot 10 includes a first camera 96 disposed along the front side 52 of the chassis and a second camera 96 disposed along the rear side 54 of the chassis 22, however, it is to be appreciated that additional cameras 96 may be included as well. Referring to FIG. 5, in one embodiment the support plate 24 defines openings 100 along the front and rear sides 52, 54 of the chassis 22 that accommodate the cameras 96. FIGS. 1 and 2A also illustrate a LiDAR sensor 98 disposed on each of the two opposing sides 50, the front side 52, and the rear side 54 of the chassis 22. Therefore, the plurality of LiDAR sensors 98 may provide a substantial or nearly 360-degree view of the surroundings of the autonomous mobile robot 10 without blind spots.

In the embodiment as shown in the figures, the two or more cameras 96 are elevated in their position relative to the terrain 92 (FIG. 5) that the autonomous mobile robot 10 traverses. That is, as seen in FIG. 5, a first height H1 measured between the terrain 92 and one of the cameras 96 is greater than a second height H2 measured between one of the LiDAR sensors 98 and the terrain 92. It is to be appreciated that the nearly 360-degree view provided by the plurality of LiDAR sensors 98 and the image data captured by the elevated cameras 96 provide a broad field-of-view to the one or more controllers 46. The one or more controllers 46 may then navigate the autonomous mobile robot 10 within the manufacturing facility based on the perception data provided by the plurality of LiDAR sensors 98 and the cameras 96.

Referring to FIGS. 2A and 5, the pallet 26 is seated on top of an upper surface 102 of the support plate 24. The pallet 26 acts as a platform to store materials that the autonomous mobile robot 10 transports throughout the manufacturing facility. Referring specifically to FIG. 2A, the pallet 26 includes a main body 104 that defines a support surface 106 and a plurality of apertures 108 that are distributed in a grid pattern along the support surface 106. It is to be appreciated that the plurality of apertures 108 of the pallet 26 are dimensioned specifically to accommodate existing racking systems. Therefore, the pallet 26 may be used to support a wide variety of materials upon the support surface 106. For example, the pallet 26 may be used to support items such as, but not limited to, a racking system, a container, a rotating sequencing kit, another pallet, or a robot.

Referring generally to the figures, the disclosed autonomous mobile robot provides various technical effects and benefits. Specifically, the autonomous mobile robot may be a dedicated material mover and container within a manufacturing environment. The pallet ensures that a wide variety of containers and racks may be employed to transport materials. Accordingly, the autonomous mobile robot ensures that there is full-time awareness of the location of the material, since the material is always paired with the autonomous mobile robot. Furthermore, because the pallet is disposed upon the uppermost or on top of the autonomous mobile robot, the autonomous mobile robot does not require docking with a cart or rack, which may result in increased time and interference issues between the robot and the cart or rack. In the event the autonomous mobile robot is immobilized due to electrical or hardware issues, or during maintenance, a lifting mechanism such as a forklift may be used to transport the autonomous mobile robot to another area of the manufacturing facility for servicing. The autonomous mobile robot also includes a track drive system that provides improved mobility across the floor of a manufacturing facility when compared to other types of mobility systems such as wheels and casters.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the modules may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An autonomous mobile robot transporting material in a manufacturing environment, the autonomous mobile robot comprising:
a chassis including a main body that defines two opposing sides, a front side, a rear side, and a lower surface that faces a terrain that the autonomous mobile robot traverses, wherein the main body defines two or more channels disposed along the lower surface of the main body that are each shaped to receive an arm of a lifting mechanism; and
a track drive system including two drive systems that are each attached to one of the two opposing sides of the chassis, wherein each drive system includes:
a track;
a pair of driven wheels; and
one or more idler wheels disposed between the pair of driven wheels, wherein the track engages the pair of driven wheels and the idler wheel.

2. The autonomous mobile robot of claim 1, wherein each channel of the chassis extends from the front side to the rear side of the chassis.

3. The autonomous mobile robot of claim 1, wherein a clearance is measured between the lower surface along one of the channels of the chassis and the terrain that the autonomous mobile robot traverses.

4. The autonomous mobile robot of claim 1, further comprising two motors and two gearboxes, wherein each of the two motors correspond to and drive one of the drive systems and the two gearboxes are each directly connected to one of the two motors.

5. The autonomous mobile robot of claim 1, wherein the two or more channels are load-bearing members of the chassis.

6. The autonomous mobile robot of claim 1, further comprising two or more cameras, wherein a first camera is disposed along the front side of the chassis and a second camera is disposed along the rear side of the chassis.

7. The autonomous mobile robot of claim 6, further comprising a LiDAR sensor disposed on each of the two opposing sides, the front side, and the rear side of the chassis.

8. The autonomous mobile robot of claim 7, wherein a first height is measured between the terrain and one of the two or more cameras is greater than a second height measured between one of the LiDAR sensors and the terrain.

9. The autonomous mobile robot of claim 1, wherein the main body of the chassis defines one or more cavities.

10. The autonomous mobile robot of claim 9, further comprising a support plate seated on top of an upper surface of the main body of the chassis to cover the one or more cavities.

11. The autonomous mobile robot of claim 10, further comprising a pallet seated on top of an upper surface of the support plate.

12. The autonomous mobile robot of claim 11, wherein the pallet includes a main body that defines a support surface and a plurality of apertures that are distributed in a grid pattern.

13. The autonomous mobile robot of claim 1, wherein the track of the track drive system includes an inner surface and an outer surface.

14. The autonomous mobile robot of claim 13, wherein the inner surface of the track includes a plurality of inner teeth that engage with corresponding teeth disposed around the pair of driven wheels and the outer surface of the track includes a plurality of outer teeth.

15. An autonomous mobile robot transporting material in a manufacturing environment, the autonomous mobile robot comprising:
a chassis including a main body that defines two opposing sides, a front side, a rear side, and a lower surface that faces a terrain that the autonomous mobile robot traverses, wherein the main body defines two or more channels disposed along the lower surface of the main body that are each shaped to receive an arm of a lifting mechanism, and wherein each channel of the chassis extends from the front side to the rear side of the chassis; and
a track drive system including two drive systems that are each attached to one of the two opposing sides of the chassis, wherein each drive system includes:
a track including an inner surface including a plurality of inner teeth and an outer surface including a plurality of outer teeth;
a pair of driven wheels including corresponding teeth, wherein the plurality of inner teeth of the track engage with the corresponding teeth disposed around the pair of driven wheels; and
one or more idler wheels disposed between the pair of driven wheels, wherein the track engages the pair of driven wheels and the idler wheel.

16. The autonomous mobile robot of claim 15, further comprising two or more cameras, wherein a first camera is disposed along the front side of the chassis and a second camera is disposed along the rear side of the chassis and a LiDAR sensor disposed on each of the two opposing sides, the front side, and the rear side of the chassis.

17. The autonomous mobile robot of claim 15, wherein the main body of the chassis defines one or more cavities.

18. The autonomous mobile robot of claim 17, further comprising a support plate seated on top of an upper surface of the main body of the chassis to cover the one or more cavities.

19. The autonomous mobile robot of claim 18, further comprising a pallet seated on top of the upper surface of the support plate.

20. An autonomous mobile robot transporting material in a manufacturing environment, the autonomous mobile robot comprising:
a chassis including a main body that defines one or more cavities, an upper surface, two opposing sides, a front side, a rear side, and a lower surface that faces a terrain that the autonomous mobile robot traverses, wherein the main body defines two or more channels disposed along the lower surface of the main body that are each shaped to receive an arm of a lifting mechanism, and wherein each channel of the chassis extends from the front side to the rear side of the chassis;
a support plate seated on top of an upper surface of the main body of the chassis to cover the one or more cavities;
a pallet seated on top of the upper surface of the support plate; and
a track drive system including two drive systems that are each attached to one of the two opposing sides of the chassis, wherein each drive system includes:
a track including an inner surface including a plurality of inner teeth and an outer surface including a plurality of outer teeth;
a pair of driven wheels including corresponding teeth, wherein the plurality of inner teeth of the track engage with the corresponding teeth disposed around the pair of driven wheels; and
one or more idler wheels disposed between the pair of driven wheels, wherein the track engages the pair of driven wheels and the idler wheel.
